(19) United States
(12) Patent Application Publication
(10) Pub. No.: US 2012/0097777 A1
(43) Pub. Date: Apr. 26, 2012

(54) STRENGTHENED CUTTING DEVICE FOR A STRIP-CUT SHREDDER

(76) Inventor: Chao-Lung Su, Taipei (TW)

(21) Appl. No.: 12/911,956

(22) Filed: Oct. 26, 2010

(51) Int. Cl. B02C 18/18

(52) U.S. Cl. 241/236

(57) ABSTRACT

A cutting device for a strip-cut shredder is mounted in a housing, is driven by a motor through a transmission gear set and has two driving shafts, two pairs of guiding brackets mounted between the driving shafts, and a bracing leaf, multiple pairs of stripping blades and multiple partitions mounted on the driving shafts. The partitions are disposed between the stripping blades. The bracing leaf holds the driving shafts to structurally enhance the driving shafts so the driving shafts are not deformed easily. Therefore, the papers are stripped thoroughly, and the transmission gear set and the motor are able to operate appropriately and keep in good conditions. Moreover, the driving shafts have saved manufacturing costs and effective shredding capabilities.

### BACKGROUND OF THE INVENTION

1. Field of the Invention

The present invention relates to a cutting device for a strip-cut shredder, especially to a cutting device that is strengthened to avoid deformation.

2. Description of the Prior Art(s)

A shredder shreds private, confidential or sensitive documents or files into small pieces to render information thereon unreadable. A conventional strip-cut shredder has a cutting device mounted in a housing. The cutting device has two driving shafts, multiple blades and multiple partitions. The driving shafts are parallelly mounted rotatably on the housing, are driven by a motor through a gear set and are rotated toward opposite directions. The blades are mounted securely around the driving shafts and are rotated along with the driving shafts. The partitions are mounted on the driving shafts and disposed between the blades to keep the shredding blades from hitting each other.

However, the conventional strip-cut shredder has the following disadvantages. Since the driving shafts are disposed on the housing only with their ends mounted rotatably on the housing, when the conventional strip-cut shredder shreds a stack of paper at a time, the driving shafts, especially middles of the driving shafts, are pulled by the stack of paper and are deformed easily. Thus, the papers are not shredded completely, and the ends of the driving shafts disengage from the gear set or push the gear set so the gear set and the motor break down. A conventional way to avoid deformation of the driving shaft is to increase thickness of the driving shafts and/or making the driving shafts with tough materials. However, manufacturing costs are also increased.

To overcome the shortcomings, the present invention provides a strengthened cutting device for a strip-cut shredder to mitigate or obviate the aforementioned problems.

### SUMMARY OF THE INVENTION

The main objective of the present invention is to provide a strengthened cutting device for a strip-cut shredder. The cutting device for a strip-cut shredder is mounted in a housing, is driven by a motor through a transmission gear set and has two driving shafts, two pairs of guiding brackets mounted between the driving shafts, and a bracing leaf, multiple pairs of stripping blades and multiple partitions mounted on the driving shafts. The partitions are disposed between the stripping blades. The bracing leaf holds the driving shafts to structurally enhance the driving shafts so the driving shafts are not deformed easily. Therefore, the papers are stripped thoroughly, and the transmission gear set and the motor are able to operate appropriately and keep in good conditions. Moreover, the driving shafts have saved manufacturing costs and effective shredding capabilities.

Other objectives, advantages and novel features of the invention will become more apparent from the following detailed description when taken in conjunction with the accompanying drawings.

### BRIEF DESCRIPTION OF THE DRAWINGS

FIG. 1 is a bottom view of a strengthened cutting device for a strip-cut shredder in accordance with the present invention, shown mounted in a housing of the strip-cut shredder;

FIG. 2 is a perspective view of the strip-cut shredder in FIG. 1;

FIG. 3 is an enlarged perspective view of the strengthened cutting device in FIG. 1;

FIG. 4 is an enlarged partial exploded perspective view of the strengthened cutting device in FIG. 1; and

FIG. 5 is a cross-sectional side view of the strengthened cutting device in FIG. 1.

### DETAILED DESCRIPTION OF THE PREFERRED EMBODIMENTS

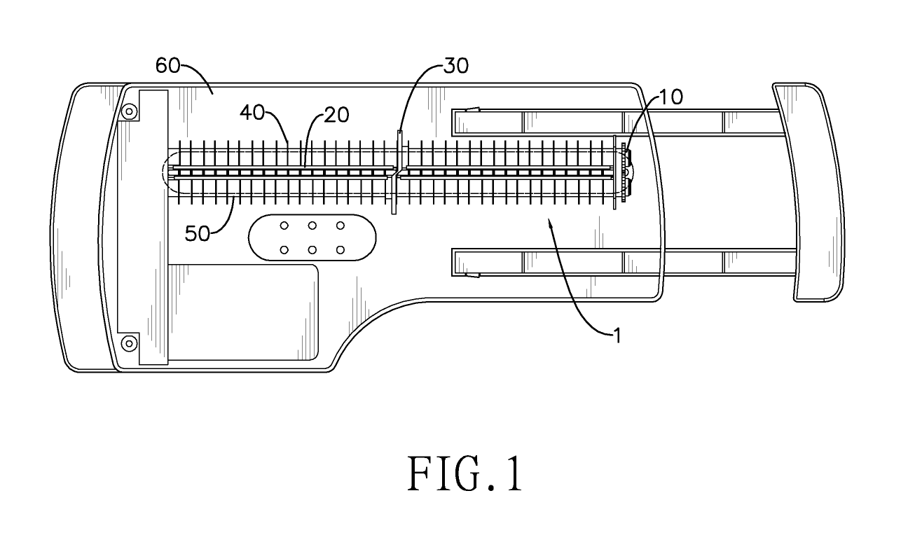

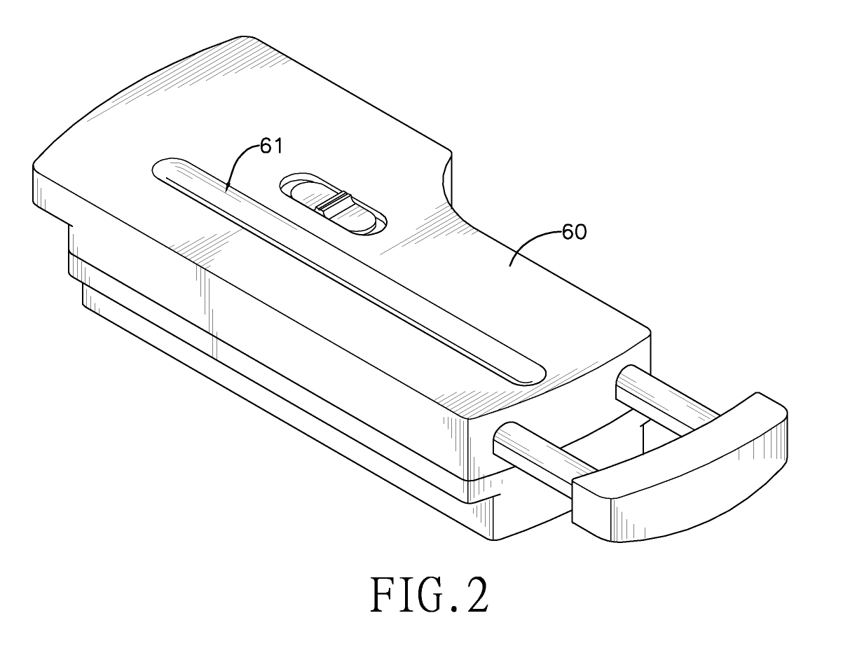

With reference to FIGS. 1 and 2, a strip-cut shredder has a housing 60 and a cutting device 1 in accordance with the present invention, a motor and a transmission gear set mounted in the housing 60. The housing 60 has an entrance 61 and an exit. The entrance 61 is formed through a top of the housing 60. The exit is formed through a bottom of the housing 60.

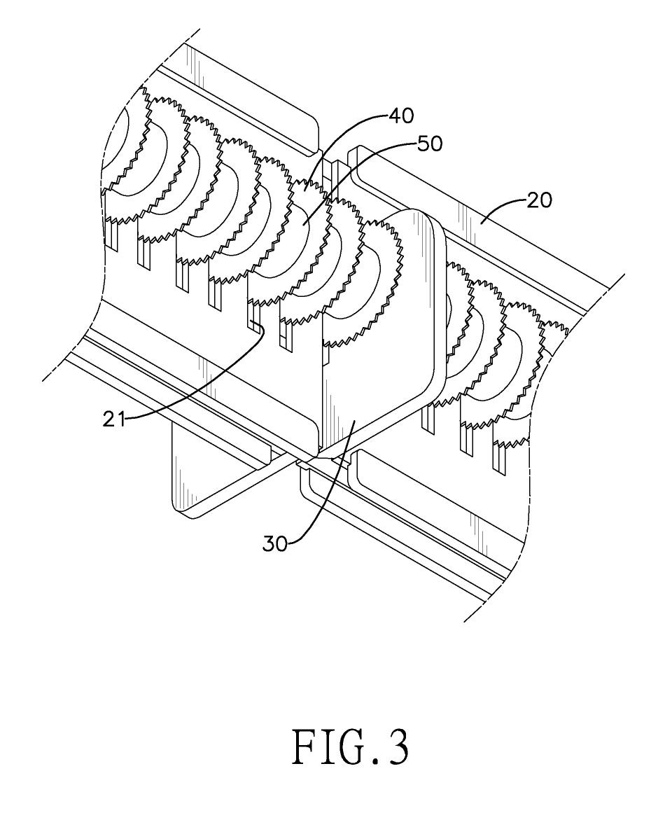

With further reference to FIG. 3, the cutting device 1 in accordance with the present invention is disposed between the entrance 61 and the exit of the housing 60 and comprises two driving shafts 10, two pairs of guiding brackets 20, a bracing leaf 30, multiple pairs of stripping blades 40 and multiple partitions 50.

The driving shafts 10 are mounted rotatably in the housing 60 and are parallel to each other.

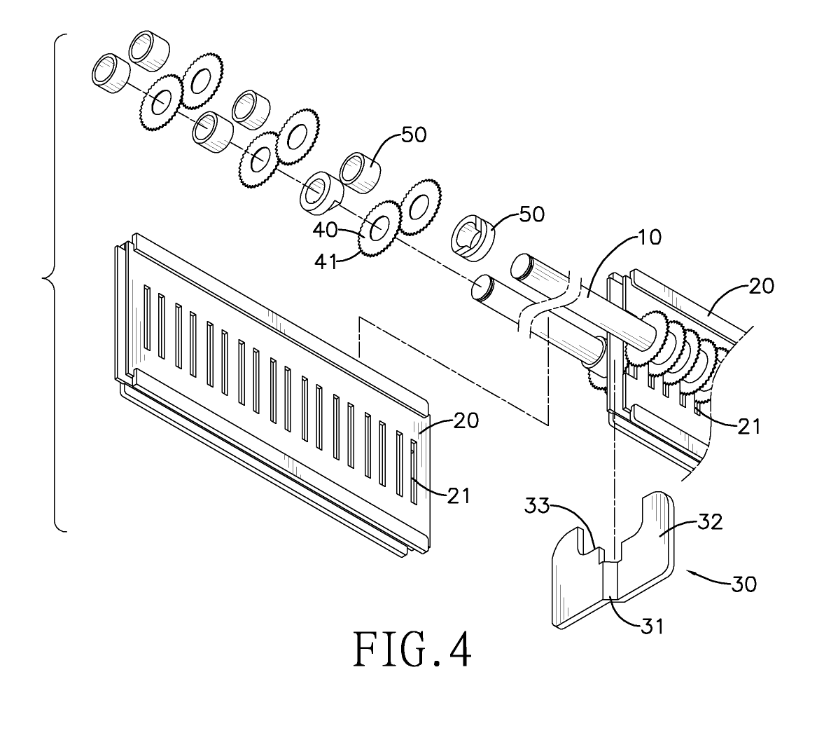

With further reference to FIG. 4, the pairs of the guiding brackets 20 are mounted between the driving shafts 10 and align with each other. Each guiding bracket 20 has multiple mounting holes 21 formed separately through the guiding bracket 20.

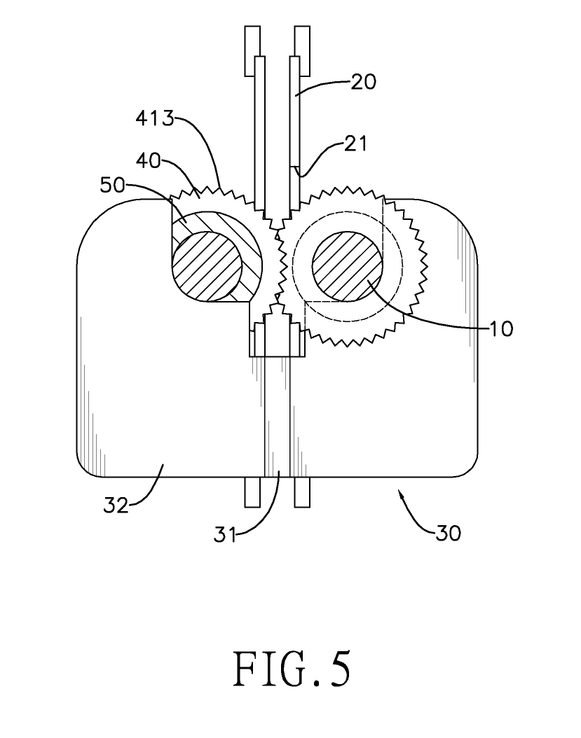

With further reference to FIG. 5, the bracing leaf 30 is mounted on the driving shafts 10, is disposed between the pairs of the guiding brackets 20 and has a bending wall 31, two sidewalls 32 and a recess 33. The bending wall 31 is disposed between the guiding brackets 20 of each pair of the guiding brackets 20. The sidewalls 32 are formed on two opposite side edges of the bending wall 31 and are parallel to and misalign with each other. The recess 33 is formed in upper edges of the bending wall 31 and the sidewalls 32 and is mounted around the driving shafts 10. Thus, the bracing leaf 30 supports and holds the driving shafts 10, and keeps the driving shafts 10 from deforming easily.

The stripping blades 40 of each pair of the stripping blades 40 are mounted respectively around the driving shafts 10, are offset to each other and are mounted through the mounting holes 21 of the guiding brackets 20. Each stripping blade 40 has multiple teeth 41 formed around a peripheral edge of the stripping blade 40. The bending wall 31 of the bracing leaf 30 allows the stripping blades 40 that are disposed by the sidewalls 32 of the bracing leaf 30 to offset to each other.

The partitions 50 are mounted around the driving shafts 10 and are disposed respectively between the stripping blades 40. Therefore, the stripping blades 40 are held securely on the driving shafts 10, and do not slide and hit each other.

The cutting device for a strip-cut shredder as described has the following advantages. As a stack of paper slides through the entrance 61 of the housing 60 and between the guiding brackets 20, the stripping blades 40 cut the papers into strips. The bracing leaf 30 that holds the driving shafts 10 structurally enhances the driving shafts 10 so the driving shafts 10 are not deformed easily. Therefore, the papers are stripped thoroughly, and the transmission gear set and the motor are able to operate appropriately and keep in good conditions. Moreover, the driving shafts 10 that are enhanced without increasing their thickness and making with tough materials have saved manufacturing costs and effective shredding capabilities.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A strengthened cutting device for a strip-cut shredder comprising two driving shafts being parallel to each other;
a bracing leaf mounted on the driving shafts and having a bending wall;
two sidewalls formed on two opposite side edges of the bending wall and being parallel to and misaligning with each other; and
a recess formed in upper edges of the bending wall and the sidewalls and mounted around the driving shafts;
multiple pairs of stripping blades separately mounted securely on the driving shafts, the stripping blades of each pair of the stripping blades mounted respectively around the driving shafts and being offset to each other, and each stripping blade having multiple teeth formed around a peripheral edge of the stripping blade; and
multiple partitions mounted around the driving shafts and disposed respectively between the stripping blades.

2. The cutting device as claimed in claim 1 further has two pairs of guiding brackets mounted between the driving shafts and aligning with each other, and each guiding bracket having multiple mounting holes formed separately through the guiding bracket;
the bracing leaf is disposed between the pairs of the guiding brackets;
the bending wall of the bracing leaf is disposed between the guiding brackets of each pair of the guiding brackets; and
the stripping blades are mounted respectively through the mounting holes of the guiding brackets.
